(19) United States
(12) Patent Application Publication
(10) Pub. No.: US 2010/0219172 A1
(43) Pub. Date: Sep. 2, 2010

(54) Process For Reducing The Loss Of Backing Gas When Welding Pipe

(75) Inventor: Frederick Schweighardt, Cypress, TX (US)

Correspondence Address: AIR LIQUIDE USA LLC;Intellectual Property, 2700 POST OAK BOULEVARD, SUITE 1800, HOUSTON, TX, 77056, US

(73) Assignee: Air Liquide Industrial U.S. LP, Houston, TX (US)

(21) Appl. No.: 12/395,915

(22) Filed: Mar. 2, 2009

(51) Int. Cl. B23K 9/00

(52) U.S. Cl. 219/137 R

(57) ABSTRACT

The present invention provides for a process for welding pipes together utilizing a cover device that has a gutter-shaped portion that is arranged on the plan of joint of the pipes to be welded together. By arranging the cover device such that the gutter-shaped portion faces and covers a portion of the plan of joint formed by the abutment of the ends of the pipes to be welded together, it is possible to eliminate or minimize the waste of gas that is utilized to create an internal gas backing.

### FIELD OF THE INVENTION

The present invention concerns a process for reducing the loss of backing gas when arc welding pipes together.

### BACKGROUND

Metal pipes, tubes, pipelines, conduits, conduct and similar materials that have to be joined together are usually welded. More precisely, the end of one pipe is first abutted to the end of another pipe in order to obtain a plan of joint formed by the circular edges of the pipe ends. The ends of each pipe can be beveled so as to typically obtain a U-, V- or Y-shaped plan of joint. A circular weld joint is then welded along the circular plan of the joint by means of a welding torch, such as an electric arc welding torch or a laser torch. For protecting the welding bead during welding, i.e., the molten metal forming the welding joint after solidification, a backing gas, for example, an inert gas such as helium, argon, or reactive gases such as hydrogen or nitrogen, or mixtures thereof, is often introduced into the pipes.

The complete welding of the joint can be done in one or several passes. The welding torch is preferably a GTAW, GMAW, MIG or MAG welding torch that is supplied with a meltable wire that is molten by the electric arc thereby providing additional metal that fills the gap formed by the bevel at the ends of the pipe.

An existing problem that exists during welding is that some of the gas that forms a backing is lost because it diffuses or passes through the plan of joint that is not yet welded. This loss of gas is detrimental for the global productivity of the welding process as it leads to the waste (gas consumption) of expensive gases, such as helium or argon.

Hence, a goal of the present invention is to overcome or at least minimize these losses of gas during welding of pipes together.

### SUMMARY OF THE INVENTION

The present invention provides for a process for welding pipes together in which the loss of backing gas is either eliminated or minimized. This process comprises:
a) providing a first pipe comprising a first free end and a second pipe comprising a second free end, said first and second pipes having an outer diameter that is substantially the same;
b) abutting the first free end of the first pipe to the second free end of the second pipe in order to obtain a plan of joint to be welded;
c) providing a cover device having a gutter-shaped portion,
d) arranging said device on said pipes so that the gutter-shaped portion faces and covers a part of the plan of joint to be welded;
e) introducing gas inside the pipes so as to create an internal gas backing;
f) arc welding said pipes along the plan of joint so as to obtain a welded joint between said first end and said second end; and
g) moving the cover device around the external surface of said pipes so that the gutter-shaped portion follows the plan of joint to be welded, while at the same time welding a part of the plan of joint not covered by said gutter-shaped portion of the cover-device.

### BRIEF DESCRIPTION OF THE FIGURES

FIG. 1 illustrates two pipes (tubes) in which the first free end of the first pipe abuts abut the second free end of the second pipe before being welded together.

FIG. 2 illustrates a schematic cross-sectional view of the pipes of FIG. 1 on which a cover-device is arranged along a part of their plan of joint.

FIG. 3 illustrates an enlarged view of the plan of joint region.

### DETAILED DESCRIPTION OF THE INVENTION

In one embodiment of the present invention, the process utilized comprises a first step of providing a first pipe that comprises a first free end and a second pipe that comprises a second free end with the first and second pipes having substantially the same outer diameter. While the term “pipe” is used herein, the term is meant to encompass not only hollow cylinders used to convey a material, but also other hollow devices that may be in a shape other than a cylindrical shape. In addition, the phrase “substantially the same outer diameter” refers to diameters of the first and second pipes that are the same or that have slight variations in diameter but are such that they may still be effectively welded together.

In the process, the first free end of the first pipe abuts the second free end of the second pipe in order to obtain a plan of joint to be welded. In order to minimize the loss of backing gas, a cover device comprising a gutter-shaped portion is provided. This cover device is arranged on the pipes so that the gutter-shaped portion faces and covers a portion of the plan of joint to be welded. Next, the gas is introduced into the pipes so as to create an internal gas backing. The pipes are then arc welded along the plan of joint in order to obtain a welded joint between said first end and said second end. As the arc welding takes place, the cover device is moved around the external surface of said pipes (along the portion where the first free end of the first pipes abuts the second free end of the second pipe to form the plan of joint to be welded) so that the gutter-shaped portion follows the plan of joint. As the gutter-shaped portion follows the plan of joint, the part of the plan of joint not covered by said gutter-shaped portion of the cover-device is welded.

Depending on the desired embodiment, the process of the present invention can comprise one or several of the flowing features:

a. the gutter-shaped portion is conformed in order to match the external surface of the pipes on each sides of the plan of joint and to allow a clearance above and around the plan of joint covered by said gutter-shaped portion.

b. the first and second pipes are both cylindrical.

c. the cover device comprises articulated gutter-shaped parts.

d. the cover device is held in place by at least a resilient device.

e. the resilient device comprises a spring.

f. the cover is made of aluminum, stainless, steel or titanium.

g. the gas backing comprises one or several compounds chosen from among nitrogen, argon, helium, oxygen, hydrogen, CO₂ or mixtures of two or more thereof.

h. arc welding is operated by means of at least a welding torch that is supplied with a meltable wire that is molten by the electric arc, such as a GTAW, GMAW, MIG or MAG torch.

One embodiment of the present invention is represented by the enclosed Figures which respectively represent the abutment of the two pipes prior to be welded together, a schematic cross-sectional view of the pipes on which a cover-device has been arranged along a part of the plan of joint of the two pipes, and an enlarged view of the plan of joint region.

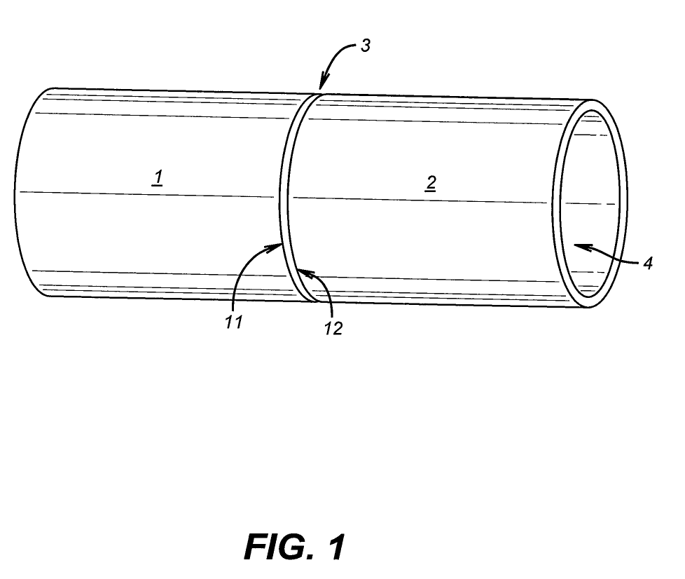

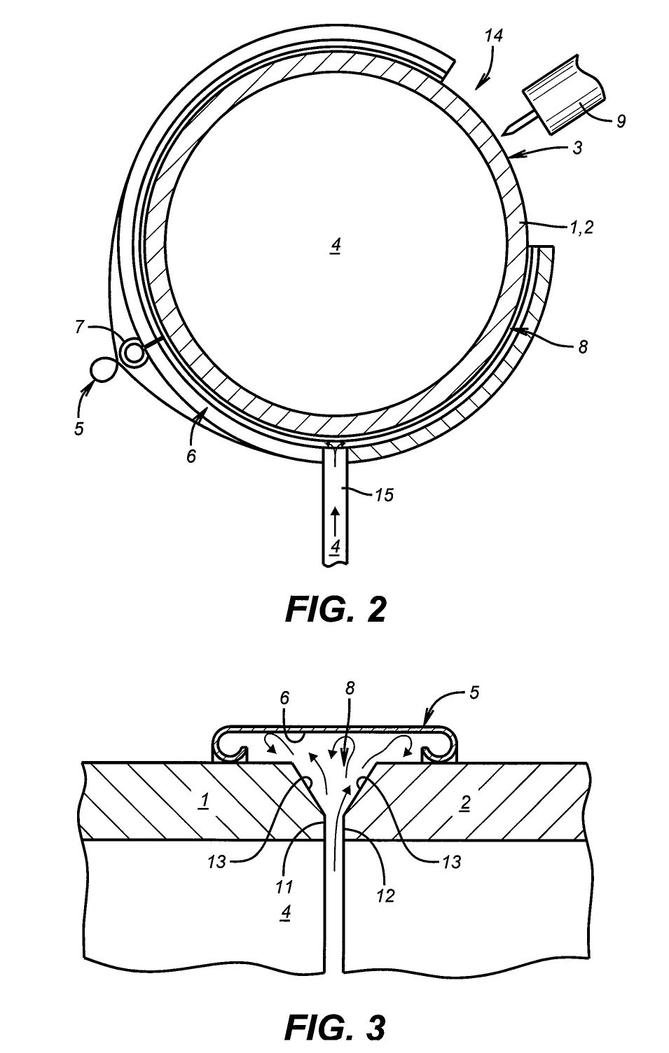

As shown in FIG. 1, a hollow first pipe 1 comprising a first free end 11 and a hollow second pipe 2 comprising a second free end 12 are arranged to allow for the abutment of the first free end 11 of the first pipe 1 to the second free end 12 of the second pipe 2 in order to obtain a circular plan of joint 3 to be welded. The first pipe 1 and second pipe 2 have substantially the same outer diameter and have beveled ends 13 (i.e. V or Y-beveling) as represented in FIG. 3.

Just before and during the welding of the two pipes together, gas 4 is introduced into the hollow pipes 1, 2. In order to prevent, at least partially minimize, losses of gas 4, a gutter-shaped 6 cover device 5 is arranged on the joint 3. In the frame of the present invention, the terms gutter-shaped 6 designate any gutter, channel, trough, or the like for diverting (carrying off) or maintaining (keeping) within a certain field fluids, especially gases.

The gutter-shaped 6 cover device 5 may be a hinged metal cover that is formed or configured to allow a small amount of clearance 8 around and above the plan of joint 3. The cover device 5 can be made in a variety of sizes in order to be arranged on pipes of various diameters. In addition, depending upon the actual shape of the pipes to be welded together, the cover device can be made in a variety of shapes to allow for a closer fit to the pipes to be welded together.

While the cover device may be made of any material that the pipes are typically made of, the cover device is preferably made of the same material as the pipes 1, 2 to prevent contamination of the base metal.

The cover device 5 may also comprise a spring 7 to keep the gutter-shaped part 6 closed around the external surface of the pipes 1, 2. The cover device 5 does not completely surround the pipes 1, 2, but instead when closed, has an open segment 14 to allow welding to take place by means of a conventional welding torch 9. In other words, when the cover device is in place, it is possible to weld a portion of the joint that is to be welded while at the same time covering the rest of the plan of joint with the cover device. The particular gutter-form of the cover device 5 provides a small point of contact on the pipe surface and thus the cover device 5 is easy to rotate around the pipes 1, 2 external surface as welding progresses. As the plan of joint is welded, the cover device is moved to the next portion of the plan of joint that needs to be welded. Accordingly, as the welding proceeds, the cover device will cover not only the section to be welded but also a section that has already been welded (the cover device can be rotated to expose the next section where welding is to take place).

The cover device 5 keeps the backing gas 4 typically used for 100% CJP welds in the weld area 8 of the gutter-part 6, as shown in FIG. 3, and therefore reduces the amount of backing gas needed since losses to the atmosphere are reduced when the cover device is used.

In some cases, the backing gas 4 is injected into the root opening of the joint with a small tube 15 arranged on the cover device. However, the cover device may also allow an injection of backing gas without using said tube 15.

The cover device 5 can also be used to provide for a trailing gas shield on reactive metals that require extra shielding gas. Most trailing gas systems simply add another source of shielding gas directed at the weld area. This cover will allow shielding gas to completely cover the entire weld area with full coverage of all heated areas. The gas flows into the tube on the cover device 5 and flows around the weld area in the annular space 8 provided by the cover device 5.

The cover device 5 slides on the rounded points of contact to allow the cover to be moved so that welding can take place at any part of the pipe joint. The cover(s) would be made to fit a specific shape and a specific size or sizes of pipes and or tubes.

The cover device 5 would typically be made of the same material as the base metal of the pipe, such as aluminum, stainless, steel, or titanium. The hinge area of the cover device 5 would be constructed to fit tightly around the pipes and prevent gas from leaking out of that area. The opening in the cover device 5 would be customizable to allow for user preference in how long of a weld is created before a cover device shift is required. The spring 7 should be of sufficient tension to hold the cover device 5 in place, but not too tightly that it binds. In automatic operations, the cover device 5 would be arranged to move automatically with the motion of the weld head or rotation of the pipe.

The complete welding of the joint can be done in one or several passes. The welding torch is preferably a GTAW, GMAW, MIG or MAG welding torch that is supplied with a meltable wire that is molten by the electric arc thereby providing additional metal that fills the gap formed by the bevel at the ends of the pipe.

What is claimed is:

1. A process for welding pipes together comprising the steps of:
a) providing a first pipe having a first free end and a second pipe having a second free end, said first pipe and said second pipe having outer diameters that are substantially the same;
b) abutting the first free end of the first pipe to the second free end of the second pipe in order to obtain a plan of joint to be welded;
c) providing a cover device comprising a gutter-shaped portion;
d) arranging the cover device on said pipes so that the gutter-shaped portion faces and covers a portion of the plan of joint;
e) introducing gas inside the pipes to create an internal gas backing;
f) arc welding said pipes along the plan of joint in order to obtain a welded joint between said first end and said second end;
g) moving the cover device around the external surface of said pipes so that the gutter-shaped portion follows the plan of joint, while welding a portion of the plan of joint not covered by said gutter-shaped portion of the cover device.

2. The process of claim 1, wherein the gutter-shaped portion is conformed so as to match the external surface of the pipes on each side of the plan of joint and to allow a clearance above and around the plan of joint covered by said gutter-shaped portion.

3. The process of claim 1, wherein the first and second pipes are both cylindrical.

4. The process of claim 1, wherein said cover device comprises articulated gutter-shaped parts.

5. The process of claim 1, wherein the cover device is held in place by at least a resilient device.

6. The process of claim 5, wherein the resilient device comprises a spring.

7. The process of claim 1, wherein the cover device is made of aluminum, stainless, steel or titanium.

8. The process of claim 1, wherein the gas backing comprises one or several compounds selected from nitrogen, argon, helium, oxygen, hydrogen, CO₂ or mixtures thereof.

9. The process of claim 1, wherein the arc welding is operated by means of at least a welding torch that is supplied with a meltable wire that is molten by the electric arc.

10. A process for welding pipes together comprising the steps of:
a) providing a cylindrical first pipe having a first free end and a cylindrical second pipe having a second free end, said first pipe and said second pipe having outer diameters that are substantially the same;
b) abutting the first free end of the first pipe to the second free end of the second pipe in order to obtain a plan of joint to be welded;
c) providing a cover device made of aluminum, stainless steel or titanium and comprising a gutter-shaped portion that matches the external surface of the pipes on each side of the plan of joint and allows a clearance above and around the plan of joint covered by said gutter-shaped portion;
d) arranging the cover device on said pipes so that the gutter-shaped portion faces and covers a portion of the plan of joint;
e) introducing gas selected from nitrogen, argon, helium, oxygen, hydrogen, CO₂ or mixtures thereof inside the pipes to create an internal gas backing;
f) arc welding said pipes along the plan of joint in order to obtain a welded joint between said first end and said second end;
g) moving the cover device around the external surface of said pipes so that the gutter-shaped portion follows the plan of joint, while welding a portion of the plan of joint not covered by said gutter-shaped portion of the cover device.

11. The process of claim 10, wherein the cover device is held in place by at least a resilient device.

12. The process of claim 11, wherein the resilient device comprises a spring.

13. The process of claim 12, wherein the arc welding is operated by means of at least a welding torch that is supplied with a meltable wire that is molten by the electric arc.
